(19) United States
(12) Patent Application Publication
(10) Pub. No.: US 2002/0190968 A1
(43) Pub. Date: Dec. 19, 2002

(54) Backlit logo assembly and method

(76) Inventors: Ron Barnes, Livermore, CA (US); Wayman Lee, Los Altos, CA (US)

Correspondence Address: Terry D. Morgan, Williams, Morgan & Amerson, P.C., Suite 250, 7676 Hillmont, Houston, TX, 77040, US

(21) Appl. No.: 09/885,339

(22) Filed: Jun. 19, 2001

(51) Int. Cl. G09G 5/00

(52) U.S. Cl. 345/204

(57) ABSTRACT

An apparatus capable of displaying a logo capable of glowing includes a light source capable of emitting light and a translucent portion corresponding to the logo, wherein the translucent portion is capable of receiving the light from the light source and is capable of allowing the light to propagate therethrough. A method capable of forming a logo badge includes molding a translucent polymeric material into a translucent portion of the logo badge and molding an opaque polymeric material into an opaque portion of the logo badge.

### BACKGROUND OF THE INVENTION

1. Field of the Invention

This invention relates to a backlit logo assembly, and, in one aspect, to a backlit logo assembly for a computer system module.

2. Description of the Related Art

As computer systems have become more powerful, user interfaces to these systems have become more sophisticated. One example of this higher level of sophistication is the addition of more and more indicator lights corresponding to various functions performed by the computer system. For example, it is common for a computer system to have indicator lights to indicate a power-on condition, hard disk access, CD-ROM access, and the like. These indicator lights are typically small and difficult to distinguish from one another. For example, each indicator light may have an adjacent icon corresponding to the function being indicated by the indicator light. These icons are often merely small markings that are part of the molded case, panel, bezel, or enclosure and are difficult to see.

It is also important to the effective marketing and branding of computer systems for the producer's logo to be easily noticed and recognized by the buying public. Computer system producers have used various coloring schemes to set their logos apart from background enclosures, panels, bezels, and molded cases. For example, a front bezel of a computer system may be a beige color, while the producer's logo is bright blue in color. As this way of distinguishing brands is common, consumers may not notice one particular logo over another.

### SUMMARY OF THE INVENTION

In one aspect of the present invention, an apparatus is provided capable of displaying a logo capable of glowing. The apparatus includes a light source capable of emitting light and a translucent portion corresponding to the logo, wherein the translucent portion is capable of receiving the light from the light source and is capable of allowing the light to propagate therethrough.

In another aspect of the present invention, a method is provided capable of forming a logo badge. The method includes molding a translucent polymeric material into a translucent portion of the logo badge and molding an opaque polymeric material into an opaque portion of the logo badge.

In a further aspect of the present invention, a logo badge is provided. The logo badge comprises a translucent portion extending through a thickness of the logo badge, wherein the translucent portion is capable of allowing light to propagate therethrough, and an opaque portion generally surrounding at least a portion of the translucent portion.

In yet another aspect of the present invention, an apparatus for displaying a logo capable of glowing is provided. The apparatus comprises a light source capable of emitting light, a bezel, and a logo badge, wherein the logo badge is disposed in the bezel.

In yet a further aspect of the present invention, a computer system is provided. The computer system comprises a chassis, a light source capable of emitting light, and a bezel adjacent the chassis. The bezel comprises a logo capable of receiving the light emitted by the light source and the logo is capable of allowing the light to propagate therethrough.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 is an exploded perspective view of a computer system and backlit logo assembly according to the present invention;

FIG. 2 is a front view of a light box and light source according to the present invention;

FIG. 3 is a schematic diagram of a computer system according to the present invention; and

FIG. 4 is a front view of a backlit logo badge according to the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

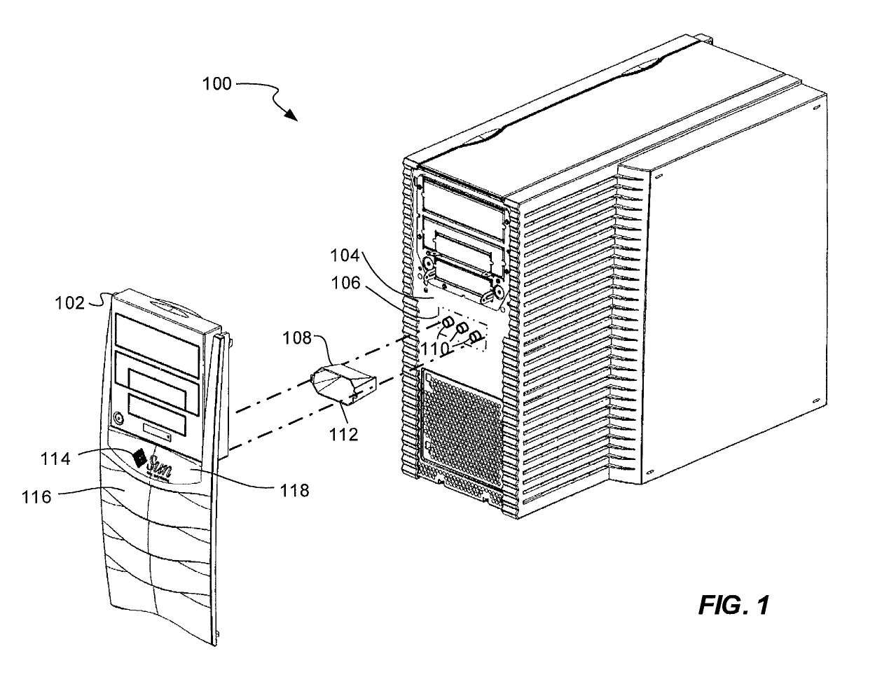

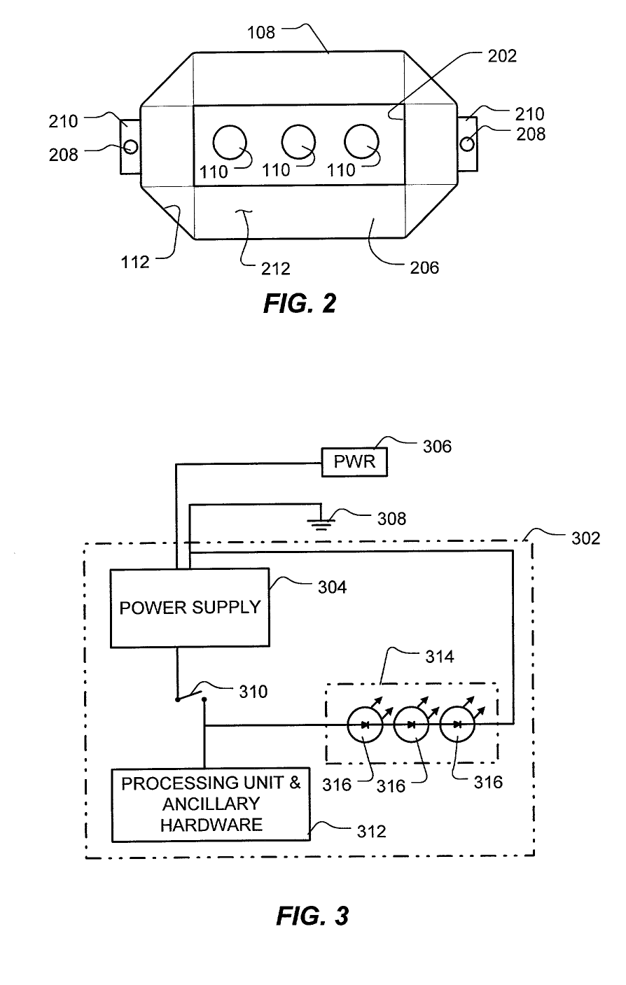

As illustrated in FIG. 1, an embodiment of the present invention comprises a computer system 100 having a front bezel 102, a chassis 104, a light source 106 and a light box 108. In the illustrated embodiment, the light source 106 comprises a plurality of light-emitting diodes (LEDs) 110; however, the scope of the present invention includes any desired light source 106, e.g., a lamp, an incandescent lamp, a neon lamp, a fluorescent, lamp, or the like. Referring now to FIG. 2, the light box 108 has a rear opening 202 in which the LEDs 110 are disposed. As indicated previously, the light source 106 comprises the LEDs 110 in the illustrated embodiment; the scope of the present invention includes any light source 106 being disposed adjacent the rear opening 202. The light box 108 further includes a front opening 112 and a wall 206 extending between the rear opening 202 and the front opening 112. In the illustrated embodiment, the wall 206 is of a faceted frustoconical configuration, as the wall 206 transitions from a rectangular shape of the rear opening 202 to an octagonal shape of the front opening 112. The scope of the present invention, however, includes any other desired shape of the rear opening 202, the front opening 112 or the wall 106. For example, if the rear opening 202 and the front opening 112 each have rectangular shapes, then the wall 206 may be faceted and have four facets. If the rear opening 202 has a rectangular shape and the front opening 112 has an oval shape, then the wall 206 may have no facets. In the illustrated embodiment, light is emitted from the LEDs 110, is reflected by an inner surface 212 of the wall 206, and is emitted from the front opening 112. While a matte inner surface 212 of the wall 206 is preferred, the inner surface 212 can have a mirror-like, polished, or other type of finish capable of reflecting light toward the front opening 112. In the illustrated embodiment, the light box 108 is attached to the front bezel 102 via attachment holes 208 in ears 210. In one embodiment according to the present invention, the light box 108 is heat-staked to the front bezel 102. In this embodiment, thermoplastic stakes (not shown) on the front bezel 102 are received in the attachment holes 208. A heat source (direct contact, induction, or the like) is applied to the stakes and the stakes are plastically deformed within the attachment holes 208 and around the ears 210 to hold the light box 108 to the front bezel 102.

Referring again to FIG. 1, the front bezel 102 includes a logo 114, which is made of a material that allows light to pass therethrough (e.g., a translucent material or the like). The logo 114 can be any term or symbol (e.g., a mark, a label, a brand, a name, a logotype, a trademark, an emblem, a device, or the like). The front opening 112 of the light box 108 is positioned behind the logo 114 and adjacent the inside surface of the front bezel 102 such that light emanating from the front opening 112 propagates through the logo 114 and is emitted by the logo 114. Thus, by observing an outside surface 116 of the front bezel 102, the logo 114 appears to the human eye to glow.

In the embodiment illustrated in FIG. 3, a computer system 302 includes a power supply 304 electrically connected to a power source 306 and to a ground 308. The computer system 302 further includes a switch 310, a processing unit and other ancillary hardware 312 and a light source 314. In the illustrated embodiment, the light source 314 comprises LEDs 316. The power supply 304 is electrically connected to the processing unit and other ancillary hardware 312 and the light source 314 when the switch 310 is in a closed position. Thus, the light source 314 provides an indication when power is supplied to the processing unit and ancillary hardware 312.

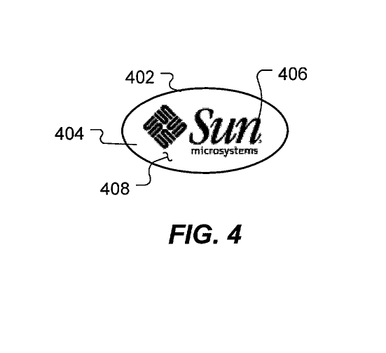

Referring now to FIG. 4, a logo badge 402 according to one embodiment of the present invention is illustrated. The logo badge 402 has an opaque portion 404 and a translucent portion 406 (indicated by darkened regions). The opaque portion 404 acts as a background to the translucent portion 406, as only the translucent portion 406 allows any substantial amount of light to propagate therethrough. In one embodiment, the logo badge 402 is an injection-molded two-shot part having a front surface 408 that corresponds the surface geometry of the portion 118 of the front bezel 102. First, a translucent polymeric material (e.g., polycarbonate or the like) is injected into a mold (not shown) portion corresponding to the translucent portion 406 of the logo badge 402. Second, an opaque polymeric material (e.g., a polycarbonate/acrylonitrile butadiene styrene material or the like) is injected into a portion of the mold corresponding to the opaque portion 404 of the logo badge 402. The opaque polymeric material flows around at least a portion of the translucent portion 406. In one embodiment, the opaque polymer is color-matched to the material of the front bezel 102. The logo badge 402 is then insert-molded into the front bezel 102 to form an integral assembly. As the front bezel 102 is molded, molten polymeric material flows around the logo badge 402. Upon cooling, the logo badge 402 and the front bezel 102 become a unified structure. In one embodiment, the translucent portion 406 acts as a light diffuser so that point light sources (e.g., LEDs 110, 316) can be used to provide a generally uniform-brightness logo 114.

In the illustrated embodiment, the light source 106 is attached to the chassis 104; however, the light source 106 can be attached to or be part of the light box 108. Further, the light source 106 can be disposed in any manner desired such that light emanating from the light source 106 is propagated through the translucent portion 406. For example, it is within the scope of the present invention for the light source 106 to provide light to the logo 114 without the light box 108.

The translucent portion 406 is capable of allowing light of various wavelengths to propagate therethrough. Accordingly, the light source 106 can emit light of a particular wavelength (or group of wavelengths) to display a logo of a particular color or a group of particular colors to indicate information about the system. For example, a particular color light might be used to indicate system health, system processing speed, or the like. Thus, the color of the light is changed according to a state of the computer system 100, 302.

The present invention further encompasses an apparatus having means for performing certain embodiments of the method of the invention described herein and their equivalents.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An apparatus capable of displaying a logo capable of glowing, comprising:
a light source capable of emitting light; and
a translucent portion corresponding to the logo, wherein the translucent portion is capable of receiving the light from the light source and is capable of allowing the light to propagate therethrough.

2. An apparatus, according to claim 1, wherein the light source is capable of emitting light of at least one color.

3. An apparatus, according to claim 1, wherein the light source is disposed behind the translucent portion.

4. An apparatus, according to claim 1, wherein the light source comprises at least one light-emitting diode.

5. An apparatus, according to claim 1, wherein the light source is a lamp selected from the group consisting of an incandescent lamp, a neon lamp, and a fluorescent lamp.

6. An apparatus, according to claim 1, wherein the translucent portion has a back surface and the apparatus further comprises a light box capable of reflecting the light emitted by the light source toward the back surface of the translucent portion.

7. An apparatus, according to claim 6, wherein the light box comprises:
a rear opening adapted to receive the light source;
a front opening capable of emitting the light from the light source, and
a wall extending therebetween capable of reflecting the light emitted from the light source toward the front opening,
wherein the front opening is adjacent the back surface of the translucent portion.

8. An apparatus, according to claim 7, wherein the wall comprises an inner surface having a matte finish.

9. An apparatus, according to claim 1, further comprising a bezel, wherein the translucent portion is disposed in the bezel.

10. An apparatus, according to claim 9, wherein the translucent portion has a back surface and the apparatus further comprises a light box capable of reflecting the light emitted by the light source toward the back surface of the translucent portion.

11. An apparatus, according to claim 9, wherein the translucent portion has a back surface and the apparatus further comprises a light box capable of reflecting the light emitted by the light source toward the back surface of the translucent portion, wherein the light box comprises:
a rear opening adapted to receive the light source;
a front opening capable of emitting the light from the light source; and
a wall extending therebetween capable of reflecting the light emitted from the light source toward the front opening,
wherein the front opening is adjacent the back surface of the translucent portion.

12. An apparatus, according to claim 11, wherein the wall comprises an inner surface having a matte finish.

13. An apparatus, according to claim 9, wherein the translucent portion has a back surface and the apparatus further comprises a light box capable of reflecting the light emitted by the light source toward the back surface of the translucent portion, wherein the light box comprises:
a rear opening adapted to receive the light source;
a front opening capable of emitting the light from the light source; and
a wall extending therebetween capable of reflecting the light emitted from the light source toward the front opening, wherein:
the front opening is adjacent the back surface of the translucent portion;
the bezel has a rear surface; and
the light box is attached to the rear surface of the bezel.

14. An apparatus, according to claim 13, wherein the wall comprises an inner surface having a matte finish.

15. An apparatus, according to claim 13, wherein the light box is heat staked to the rear surface of the bezel.

16. A logo badge, comprising:
a translucent portion extending through a thickness of the logo badge, wherein the translucent portion is capable of allowing light to propagate therethrough; and
an opaque portion generally surrounding at least a portion of the translucent portion.

17. A logo badge, according to claim 16, wherein the translucent portion is capable of allowing light of various wavelengths to propagate therethrough.

18. A logo badge, according to claim 16, wherein the logo badge is capable of being insert molded into a bezel.

19. A logo badge, according to claim 18, wherein the opaque portion has a color corresponding to a color of the bezel.

20. An apparatus for displaying a logo capable of glowing, comprising:
a light source capable of emitting light;
a bezel; and
a logo badge comprising:
a translucent portion corresponding to the logo, wherein the translucent portion is capable of receiving the light from the light source and propagating the light therethrough; and
a background portion generally surrounding at least a portion of the translucent portion,
wherein the logo badge is disposed in the bezel.

21. An apparatus, according to claim 20, wherein the light source is capable of emitting light of at least one color.

22. An apparatus, according to claim 20, wherein the light source comprises at least one light-emitting diode.

23. An apparatus, according to claim 20, wherein the light source comprises a lamp selected from the group consisting of an incandescent lamp, a neon lamp, and a fluorescent lamp.

24. An apparatus, according to claim 20, wherein the translucent portion has a back surface and the apparatus further comprises a light box capable of reflecting the light emitted by the light source toward the back surface of the translucent portion.

25. An apparatus, according to claim 24, wherein the light box comprises:
a rear opening adapted to receive the light source;
a front opening capable of emitting the light from the light source; and
a wall extending therebetween capable of reflecting the light emitted from the light source toward the front opening,
wherein the front opening is adjacent the back surface of the translucent portion.

26. An apparatus, according to claim 25, wherein the wall comprises an inner surface having a matte finish.

27. An apparatus, according to claim 24, wherein the translucent portion has a back surface and the apparatus further comprises a light box capable of reflecting the light emitted by the light source toward the back surface of the translucent portion, wherein the light box comprises:
a rear opening adapted to receive the light source;
a front opening capable of emitting the light from the light source; and
a wall extending therebetween capable of reflecting the light emitted from the light source toward the front opening,
wherein the front opening is adjacent the back surface of the translucent portion.

28. An apparatus, according to claim 27, wherein the wall comprises an inner surface having a matte finish.

29. An apparatus, according to claim 24, wherein the translucent portion has a back surface and the apparatus further comprises a light box capable of reflecting the light emitted by the light source toward the back surface of the translucent portion, wherein the light box comprises:
a rear opening adapted to receive the light source;
a front opening capable of emitting the light from the light source; and
a wall extending therebetween capable of reflecting the light emitted from the light source toward the front opening, wherein:
the front opening is adjacent the back surface of the translucent portion;
the bezel has a rear surface; and
the light box is attached to the rear surface of the bezel.

30. An apparatus, according to claim 29, wherein the wall comprises an inner surface having a matte finish.

31. An apparatus, according to claim 29, wherein the light box is heat staked to the rear surface of the bezel.

32. A computer system, comprising:
a chassis;
a light source capable of emitting light; and
a bezel adjacent the chassis, wherein the bezel comprises a logo capable of receiving the light emitted by the light source and the logo is capable of allowing the light to propagate therethrough.

33. A computer system, according to claim 32, wherein the light source is capable of emitting light of at least one color.

34. A computer system, according to claim 32, wherein the light source comprises at least one light-emitting diode.

35. A computer system, according to claim 32, wherein the light source comprises a lamp selected from the group consisting of an incandescent lamp, a neon lamp, and a fluorescent lamp.

36. A computer system, according to claim 32, wherein the light source is attached to the chassis.

37. A computer system, according to claim 32, wherein the logo comprises a translucent portion.

38. A computer system, according to claim 32, further comprising a light box capable of reflecting the light emitted by the light source toward the logo.

39. A computer system, according to claim 38, wherein the translucent portion has a back surface and the apparatus further comprises a light box capable of reflecting the light emitted by the light source toward the back surface of the translucent portion, wherein the light box comprises:
a rear opening adapted to receive the light source;
a front opening capable of emitting the light from the light source; and
a wall extending therebetween capable of reflecting the light emitted from the light source toward the front opening,
wherein the front opening is adjacent the back surface of the translucent portion.

40. An apparatus, according to claim 39, wherein the wall comprises an inner surface having a matte finish.

41. A computer system, according to claim 38, wherein the translucent portion has a back surface and the apparatus further comprises a light box capable of reflecting the light emitted by the light source toward the back surface of the translucent portion, wherein the light box comprises:
a rear opening adapted to receive the light source;
a front opening capable of emitting the light from the light source; and
a wall extending therebetween capable of reflecting the light emitted from the light source toward the front opening, wherein:
the front opening is adjacent the back surface of the translucent portion;
the bezel has a rear surface; and
the light box is attached to the rear surface of the bezel.

42. An apparatus, according to claim 41, wherein the wall comprises an inner surface having a matte finish.

43. A computer system, according to claim 41, wherein the light box is heat staked to the rear surface of the bezel.

44. A computer system, according to claim 32, further comprising:
a processing unit;
a power source; and
a switch electrically interconnected with the light source and the processing unit,
wherein power from the power supply is supplied to the processing unit and the light source when the switch is in a closed position.

45. A method capable of forming a logo badge, comprising:
molding a translucent polymeric material into a translucent portion of the logo badge; and
molding an opaque polymeric material into an opaque portion of the logo badge.

46. A method, according to claim 45, wherein molding the opaque polymeric material further comprises flowing the opaque polymeric material around the translucent portion.

47. A method, according to claim 45, wherein:
molding the translucent polymeric material further comprises injection molding the translucent polymer; and
molding the opaque polymeric material further comprises injection molding the opaque polymer.

48. A method capable of forming a bezel having a translucent logo, comprising:
molding at least one logo badge comprising the translucent logo;
inserting the logo badge into a mold capable of molding the bezel; and
molding a polymeric material into the bezel.

49. A method, according to claim 48, wherein molding the polymeric material further comprises flowing the polymeric material around the logo badge.

50. A method, according to claim 48, wherein molding the logo badge further comprises:
molding a translucent polymeric material into a translucent portion of the logo badge; and
molding an opaque polymeric material into an opaque portion of the logo badge.

51. A method, according to claim 50, wherein molding the opaque polymeric material further comprises flowing the opaque polymeric material around the translucent portion.

52. A method, according to claim 48, wherein:
molding the translucent polymeric material further comprises injection molding the translucent polymeric material; and
molding the opaque polymeric material further comprises injection molding the opaque polymeric material.

53. A method, according to claim 48, further comprising staking a light box to an inside surface of the bezel.

54. An apparatus capable of forming a logo badge, comprising:
means for molding a translucent polymeric material into a translucent portion of the logo badge; and
means for molding an opaque polymeric material into an opaque portion of the logo badge.

55. An apparatus, according to claim 54, wherein the means for molding the opaque polymeric material further comprises means for flowing the opaque polymeric material around the translucent portion.

56. An apparatus, according to claim 54, wherein:
the means for molding the translucent polymeric material further comprises means for injection molding the translucent polymer; and
the means for molding the opaque polymeric material further comprises means for injection molding the opaque polymer.

57. An apparatus capable of forming a bezel having a translucent logo, comprising:
means for molding at least one logo badge comprising the translucent logo;
means for inserting the logo badge into a mold capable of molding the bezel; and
means for molding a polymeric material into the bezel.

58. An apparatus, according to claim 57, wherein the means for molding the polymeric material further comprises means for flowing the polymeric material around the logo badge.

59. An apparatus, according to claim 57, wherein the means for molding the logo badge further comprises:
means for molding a translucent polymeric material into a translucent portion of the logo badge; and
means for molding an opaque polymeric material into an opaque portion of the logo badge.

60. An apparatus, according to claim 57, wherein the means for molding the opaque polymeric material further comprises means for flowing the opaque polymeric material around the translucent portion.

61. An apparatus, according to claim 57, wherein:
the means for molding the translucent polymeric material further comprises means for injection molding the translucent polymeric material; and
the means for molding the opaque polymeric material further comprises means for injection molding the opaque polymeric material.

62. An apparatus, according to claim 57, further comprising means for staking a light box to an inside surface of the bezel.

63. A method of displaying a glowing logo in a computer system, comprising:
propagating a light corresponding to the logo; and
changing a color of the light according to a state of the computer system.
